(19) United States
(12) Patent Application Publication
(10) Pub. No.: US 2012/0008890 A1
(43) Pub. Date: Jan. 12, 2012

(54) BEARING RACE HAVING ELECTRICAL INSULATION AND METHOD FOR PRODUCING THE SAME

(75) Inventors: Sergej Schwarz, Nuernberg (DE); Gudrun Martin, Euerbach (DE); Frank Steinhauer, Forst (DE)

(73) Assignee: SCHAEFFLER TECHNOLOGIES GMBH & CO. KG, (DE)

(21) Appl. No.: 13/257,438

(22) PCT Filed: Mar. 19, 2010
(86) PCT No.: PCT/DE10/00330

§ 371 Date: Sep. 19, 2011

(30) Foreign Application Priority Data
Mar. 27, 2009 (DE) 10 2009 014 753.5

(51) Int. Cl. F16C 33/62; B32B 37/14; B32B 37/02

(52) U.S. Cl. 384/476; 156/185

(57) ABSTRACT

A method for producing a bearing race which has electrical insulation for a rolling bearing, and a bearing race for a rolling bearing produced, for example, by the method. The method includes the steps of: providing a body of the bearing race, applying a multilayer insulating coating enclosing the body of the bearing race at least in segments by winding the body of the bearing race with a carrier material enclosed by a resin for forming the electrical insulation. The insulating layer has an additive improving the electrical properties, particularly the dielectric properties, and/or mechanical properties of the electrical insulation. A bearing race and a method for producing a bearing race are disclosed. The bearing race is particularly suitable for shield alternating currents.

### FIELD OF INVENTION

The invention concerns a method as claimed in claim 1 for producing a bearing race having an electrical insulation for a rolling bearing, a bearing race as claimed in claim 15 or 16 and a rolling bearing as claimed in claim 17.

It is known in practice to require that current is prevented from passing through a bearing, since otherwise so-called electrocorrosion occurs, damaging the bearing. The requirement for an electrically insulated bearing arises in particular in connection with electric motors, generators or wheelset bearings, for rail vehicles for example.

Electrically insulated bearings known from the prior art are designed in particular for suppressing any passing of direct current through the bearing. For this purpose, an insulation, in particular an electrically insulating coating, is applied to one of the hearing races, so that a high electrical breakdown field strength is required to allow current to pass through the bearing.

DE 1 243 944 B describes a phosphate layer as an electrical insulation on an outer surface of a body of a hearing race of a rolling bearing. The phosphate layer is in this case applied wet-chemically.

DE 101 37 785 A1 describes a method for forming an electrical insulation of a bearing race for a rolling bearing, a sprayed ceramic layer being applied to a surface of a body of the bearing race.

DE 101 61 820 A1 and DE 10 2007 000 436 T5 likewise describe ceramic layers as electrical insulation of a hearing race.

It is also known to produce a bearing race of a rolling hearing having an electrical insulation in such a way that the body of the bearing race is provided and is fixed on a holding mandrel. The electrical insulation is formed by providing an insulating layer which surrounds the body of the bearing race at least in segments, for example on the outer lateral surface of the body, the insulating layer being of a multilayer form and produced by winding around the body of the bearing race a filamentary or strip-like carrier material surrounded by a resin, specifically a glass filament of about 50 to 100 μm in diameter, which has been immersed for example in phenolic resin. Directly before it is wound around, the glass filament is in this case passed through the resin, so that the wound glass filament is wetted with the resin on the outside. After the resin has solidified, a multilayer coating is produced, consisting of glass fibers that are arranged in the resin.

The bearing races formed by the aforementioned method have as electrical insulation substantially homogeneous layers, which require a high breakdown field strength, so that the electrical insulations are suitable in particular for the shielding of direct current.

However, the bearing races produced by the methods mentioned are only suitable to a limited extent for electrical shielding with respect to alternating currents. In particular, alternating currents give rise to capacitive, frequency-dependent resistances, for which under some circumstances a high-impedance homogeneous coating represents a scarcely suitable resistance.

Especially the use of high-speed bipolar transistors makes highly dynamic operation of variable-speed drives possible. Voltages and currents occurring in the region of the rolling bearings thereby likewise undergo highly dynamic changes, so that new types of alternating currents occur, necessitating a specifically adapted electrical insulation. In particular, interaction of a common-mode voltage and a machine capacitance in EHD operation gives rise to a voltage difference between the two bearing races of the rolling bearing that leads to a pulsed current as soon as there is a discharge (known as EMD current, Electric Discharge Machining current): current intensities of up to 3 amperes occur here at frequencies up to several MHz. Furthermore, eddy currents occur if a grounding current flows between the housing and ground, causing an annular magnetic flux around the shaft mounted in the hearing, and consequently an eddy current in the bearing races. Typical current intensities here are likewise around several amperes at frequencies of several hundred kilohertz Likewise, so-called rotor ground currents may occur if the rotor mounted in the rolling bearing is grounded and the grounding impedance is less than the impedance of the housing in which the rolling bearing is accommodated. The current intensity or the frequencies of the rotor ground currents lie in the range specified for the eddy currents. Furthermore, residual currents may occur between various capacitances and their influence is difficult to estimate.

### OBJECT OF THE INVENTION

It is the object of the invention to provide a method for producing a bearing race for a rolling bearing that is suitable in particular for the shielding of alternating currents.

### SUMMARY OF THE INVENTION

This object is achieved according to the invention by a bearing race as claimed in claim 14 or 15, produced for example by the method as claimed in claim 1, by the insulating layer containing an additional substance which improves the electrical, in particular dielectric, and/or mechanical properties of the electrical insulation.

On account of the additional substance in the insulating layer, the electrical properties of the electrical insulation can be set such that the bearing race also has, in particular, an improved insulating effect with respect to alternating currents. The additional substance is in this case present as a solid phase delimited from the surrounding resin or the carrier material and may have been added to the still liquid resin or applied to, for example sprayed onto, the still liquid resin wetting the carrier material during the implementation of the method according to the invention.

The material form of the additional substance in the insulating layer, specifically the choice of the material for the additional substance, represents a degree of freedom that can be used to form an insulation that is optimized in particular with respect to alternating currents. As an alternative or in addition to this, the geometrical form of the additional substance represents a further degree of freedom. For example, the additional substance may take the form of powder or filaments arranged in the insulating layer. Furthermore, it is possible to form the filamentary or strip-like carrier of the resin layer from the material of the additional substance. Finally, there is the possibility of providing a gradient, whether in the material form or in the geometrical form of the additional substance. For example, after the surface of the body of the bearing race, the additional substance may take the form of particles of a first material and, at a distance from the surface of the body of the bearing race, it may take the form of filaments of the same or a further material, so that a gradient perpendicular to the surface of the body of the bearing race is obtained.

Such freedom of design of the form of the insulating layer is made possible by a method as claimed in claim 1, in that the additional substance is, for example, added to the resin through which the filamentary or strip-like carrier material is passed before the carrier material wetted with the resin is wound around the body of the hearing race. It also becomes possible to choose the material of the carrier material to be from the additional substance, so that, instead of or in addition to glass fibers, filaments or strips of the additional substance are wetted by the resin.

It is preferably provided with regard to the method that the additional substance has a relative dielectric constant of less than about 3 and a very small dielectric loss factor. This produces a bearing race which has in the insulating layer an additional substance which has a relative dielectric constant of less than about 3 and a very small dielectric loss factor. On account of the small dielectric constant and the very small dielectric loss factor, the bearing race is suitable in particular for electrical shielding with respect to alternating currents in the range of several hundred kilohertz to several megahertz and consequently for a range in which the ECD, eddy or grounding currents mentioned at the beginning occur.

Provided, for example, as the material for the additional substance is PTFE, the relative dielectric constant of which in the specified range is about 2.1 and the dielectric loss factor tan(δ) of which is less than 0.0001. This forms an electrically insulating layer with a capacitance which is less than the grounding capacitance of the rolling bearing and of the housing, so that in particular the rotor ground currents no longer take the path through the rolling bearing, but the path through the grounding.

The additional substance, for example the PTFE, may be provided as particles or fibers in the insulating layer or, as an alternative or an addition to this, as the material for the carrier material, so that the carrier material comprises PTFE fibers either exclusively or in addition to glass fibers. The particles or the fibers may in this case be added to the resin that surrounds the carrier material.

It is preferably provided that the single or further additional substance comprises a ceramic, in particular an oxidic or nitridic ceramic. The ceramic in this case sets the dielectric properties of the insulating layer over a wide range. When using a ceramic with temperature-independent dielectric properties, the electrical insulation also changes only little during the operation of the rolling hearing.

It is preferably provided with regard to the selection of the ceramic that the relative dielectric constant of the ceramic has a substantially temperature-independent variation.

As an alternative to this, it may preferably be provided for a substantially temperature-independent variation of the relative dielectric constant of the ceramic that the ceramic is formed as a mixture of at least two ceramic subcomponents, the mixture of the at least two ceramic subcomponents having a substantially temperature-independent variation of the relative dielectric constant. The two ceramic subcomponents may be chosen such that the first subcomponent comprises a first substance, which has a variation of the dielectric properties increasing with temperature, and the second subcomponent comprises a substance which has a variation of the dielectric properties decreasing with temperature. The mixing of the two subcomponents of the ceramic, especially the material selection of the subcomponents or the selection of the mixing ratio of the subcomponents, ensures that the resultant mixture forms a ceramic of which the dielectric constant has a largely temperature-independent variation. Especially suitable are subcomponents such as TiO₂, Ba₂Ti₉O₂₀ or MgTiO₃, which in each case have a linear variation of the dielectric properties with temperature.

During the implementation of the method, a ceramic or a ceramic subcomponent with the properties specified above, provided as particles or fibers in the insulating layer and added for example as a powder to the resin, is used as the additional substance.

It is preferably provided that the single or further additional substance has a macromolecular material with a high proportion of oxygen atoms per molecule and a low flash point. On account of the high proportion of oxygen atoms per molecule and on account of the low flash point, the macromolecular material has the advantage in the insulating layer of the bearing race of suppressing propagation of a breakdown through the entire insulating layer in the presence of electrically conducting, in particular metallic, grains in the insulating layer. If a dielectric breakdown through the insulating layer forms, the macromolecules evaporate and react with the metallic grains to form reaction products such as water or carbon dioxide, the energy of the electrical breakdown being absorbed in the chemical conversion. The electrical breakdown consequently produces a void in the insulating layer, without passing completely through the insulating layer, so that the insulating layer retains its insulating effect.

The use of a cellulose, in particular of wool or paper, as the macromolecular material with a high proportion of oxygen atoms per molecule with a low flash point is preferably envisaged, so that it is preferably provided that the additional substance comprises the cellulose, in particular the wool or paper, during the implementation of the method. The cellulose may be added to the liquid resin, for example by introducing particles of paper or wool into the resin. As an alternative or in addition to this, it is provided that the cellulose, specifically the wool or the paper, is provided as carrier material, possibly as additional carrier material, for example in addition to glass fibers.

It is preferably provided that the single or further additional substance improves the mechanical damping of the insulating layer. During the implementation of the method, it is provided for this purpose that material which has a good damping behavior with respect to mechanical vibrations is used as the single or further additional substance. The material is provided as particles or fibers in the electrical insulating layer or, as an alternative or in addition to this, as an addition to the resin.

In particular, it is preferably provided that the additional substance comprises a polyurethane.

It is preferably provided that the one or further additional substance comprises lead particles or lead filaments. Lead particles or lead filaments, for example in the form of fibers or as the material of the carrier material, increase the durability of the insulating layer with respect to high-energy radiation, in particular radioactive radiation. The lead particles or fibers of lead may be added to the resin; as an alternative or in addition, it may be provided that the carrier material comprises filaments of lead, possibly in addition to other filaments, in particular in addition to glass fibers, as carrier material.

It is preferably provided that the at least one additional substance is formed as particles or filaments that are added to the resin. During the forming of the multilayer insulating layer, a gradient within the insulating layer can be easily produced by a specific addition of the particles or filaments to the resin. In addition, particles or filaments as an addition to the resin can be easily controlled and monitored in terms of quantity and reduce the amount of resin that is required to form an insulating layer of a certain thickness.

As an alternative or in addition to the forming of the at least one additional substance as particles or filaments, it is preferably provided that the at least one additional substance is selected as the material of at least part of the carrier material. This allows both the carrier material and the additional substance taken up in the resin to consist of the same material or different materials. In particular, it is possible to choose instead of the glass fibers or in addition to the glass fibers the additional substance both as a dielectric and for mechanically stabilizing the insulating layer.

Further advantages and features of the invention are evident from the dependent claims and the description of an exemplary embodiment.

The invention is described and explained in more detail below with reference to the accompanying drawing.

### BRIEF DESCRIPTION OF THE DRAWING

FIG. 1 shows a schematic cross-sectional view of a preferred exemplary embodiment of a hearing race according to the invention, produced by a preferred implementation of the method according to the invention, of a preferred exemplary embodiment of a rolling bearing according to the invention.

### DETAILED DESCRIPTION OF THE DRAWING

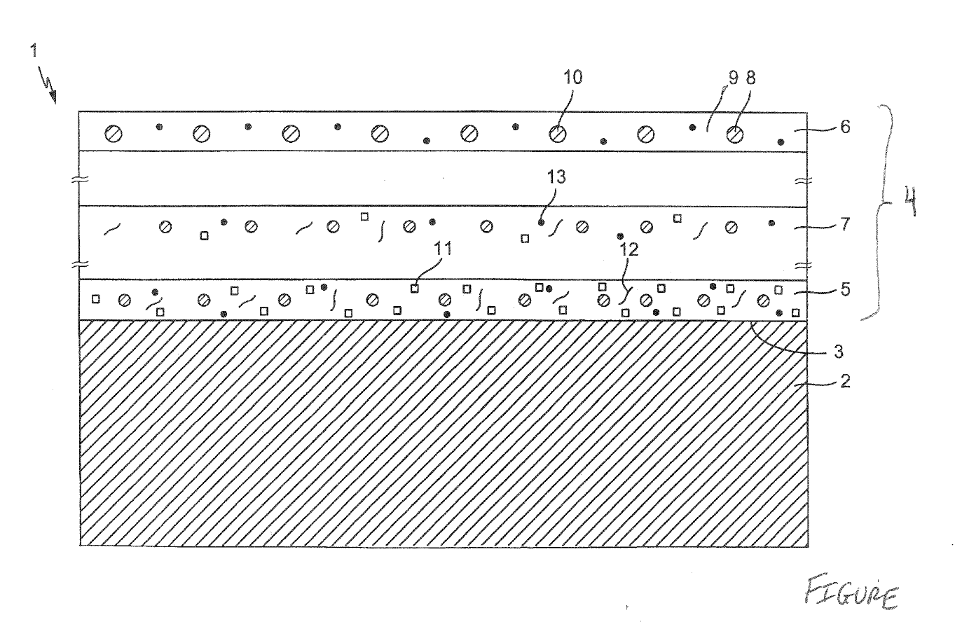

It should be stated in advance that FIG. 1 only represents a greatly schematized exemplary embodiment; in particular, the relative sizes of the individual parts are not to scale. Similarly, successive layers are not separated from one another by a definite boundary surface.

FIG. 1 shows a bearing race 1, which is intended as an outer race of a rolling bearing not represented any further, the bearing race 1 having a body 2, on the outer lateral surface 3 of which an electrical insulation formed as a multilayer insulating layer 4 has been applied.

The insulating layer 4 comprises a first layer 5, which has been applied directly to the outer lateral surface 3 as a surface of the body 2, a second layer 6, which is arranged at the greatest possible distance from the outer lateral surface 3, and a third layer 7, which is arranged substantially centrally between the first layer 5 and the second layer 6.

Each of the layers 5, 6, 7 is formed by a carrier material 8 and a solid resin material 9, in the present case phenolic resin, surrounding the carrier material 8. Serving as the material of the carrier material 8 are PTFE filaments, which are wound in layers, respectively from right to left or from left to right, around the body 2, so that a crosswise pattern is obtained in a plan view of the lateral surface 3.

To improve the mechanical and electrical properties, in particular to produce an insulation that is as good as possible under AC voltage, the material of the carrier material 8 has been provided as PTFE. The PTFE filaments of the carrier material 8 are consequently formed as a first additional substance 10 taken up in the resin matrix 9, and consequently in the insulating layer 4.

As a further, second additional substance 11, the insulating layer 4 comprises PTFE particles, which are arranged with a higher concentration in the first layer 5 than in the second layer 6, so that a gradient is obtained in a direction perpendicular to the surface 2.

The PTFE filaments 10 of the carrier material 8 and the PTFE particles 11 have in the range from several hundred kilohertz to about several megahertz a relative dielectric constant of less than about 3 and an only very small dielectric loss factor.

As a further, third additional substance 12, the insulating layer 4 has filaments of cellulose, in particular of cotton or of paper. The concentration of the cellulose filaments 12 is higher in the first layer 5 than in the second layer 6, so that a gradient is likewise formed in a direction perpendicular to the surface 3. The concentration of the cellulose filaments 12 increasing toward the body 2 allows for the prevention of a puncturing of the insulating layer 4 by an electrical breakdown originating from the lateral surface 3 of the body 2. Interacting with the cellulose filaments 12 for this purpose are electrically conducting grains, which are not depicted and the volume density of which likewise increases toward the lateral surface 3 of the body 2.

As a further, fourth additional substance 14, the insulating layer 4 comprises beads of a polyurethane, which are provided in the insulating layer 4 with a substantially constant volume density.

The bearing race 1 has been produced in such a way that the body 2 with the surface 3 was provided. Subsequently, the insulating layer 4 was produced by repeatedly winding around the surface 3. For this purpose, the PTFE filaments of the carrier material 8 were introduced into the resin and wound in layers onto the body 2.

For introducing the first additional substance 10 into the insulating layer 4, PTFE was selected as the material for the filaments of the carrier material 8.

For introducing the further additional substances 11, 12, 13, PTFE particles 11, cellulose filaments 12 and polyurethane heads 13 were respectively added to the still liquid resin 9 as powder, in each case adhering to the resin 9 and being attached with the resin 9 to the outside of the PTFE filaments of the carrier material 8. During the winding around the surface 3, the resin 9 bonds neighboring turns of the PTFE filament to form the resin matrix 9, in which the additional substances 11, 12 and 13 are taken up.

Provided as the carrier material 8 in the case of the exemplary embodiment described above was a PTFE filament which was wound repeatedly around the surface 3 of the body 2 within each layer 5, 6, 7. It goes without saying that the carrier material 8 does not need to be a substantially one-dimensional filament of an approximately round cross section. The carrier material may also have a flattened cross section, for example may take the form of a strip. Furthermore, the carrier material may also be formed as a substantially two-dimensional woven or spunbonded fabric. It also goes without saying that the carrier material 8 may also consist of different materials; for example, glass fibers may be provided in addition to or instead of the PTFE fibers. Likewise, a ceramic, in particular a blank of a ceramic sheet, may be provided for example instead of PTFE as the material for the carrier layer 8.

In the case of the exemplary embodiment described above, the second additional substance 11 and the third additional substance 12 had in each case a gradient in the concentration in a direction perpendicular to the surface 3 of the body 2. It goes without saying that the respective additional substances 10, 11, 12, 13 may also have a gradient along the surface 3. For example, the number of turns per unit area of the first additional substance 10, chosen as the carrier material 8, may increase in one direction along the surface 3. As an alternative or in addition to this, the concentration of the additional substances 11, 12, 13 in the form of particles or filaments may have a gradient along the surface 3.

The invention has been described above on the basis of an exemplary embodiment in which the resin matrix 9 was formed from a phenolic resin. It goes without saying that an epoxy resin or a mixture of phenolic resin and epoxy resin may also be provided instead of the phenolic resin.

### LIST OF DESIGNATIONS

1 Bearing Race
2 Body of the Bearing Race 1
3 Surface of the Body 2
4 Insulating Layer
5 First Layer
6 Second Layer
7 Third Layer
8 Carrier Material
9 Resin Matrix
10 First Additional Substance
11 Second Additional Substance
12 Third Additional Substance
13 Fourth Additional Substance

1-17. (canceled)

18. A method for producing a bearing race having an electrical insulation layer for a rolling hearing, the method comprising the steps of:
providing a body having a lateral outer surface; and
applying multiple insulating layers by winding around the body a carrier material in a resin matrix to form the electrical insulation layer, the resin matrix having an additional substance for effecting electrical or mechanical properties of the electrical insulation layer.

19. The method as claimed in claim 18, wherein the additional substance has a relative dielectric constant of less than 3 and a small dielectric loss factor.

20. The method as claimed in claim 19, wherein the additional substance comprises PTFE.

21. The method as claimed in claim 18, wherein the additional substance comprises a ceramic.

22. The method as claimed in claim 21, wherein the ceramic is an oxidic or nitridic ceramic.

23. The method as claimed in claim 21, wherein the ceramic has a dielectric constant, and the dielectric constant has a substantially temperature-independent variation.

24. The method as claimed in claim 21, wherein the ceramic is a mixture of at least two ceramic subcomponents and one of the mixture of the at least two ceramic subcomponents has a substantially temperature-independent variation of the dielectric constant than the other of the at least two ceramic subcomponents.

25. The method as claimed in claim 18, wherein the additional substance is a macromolecular material with a high proportion of oxygen atoms per molecule and a low flash point.

26. The method as claimed in claim 25, wherein the additional substance comprises a cellulose.

27. The method as claimed in claim 26, wherein the cellulose is a wool or a paper.

28. The method as claimed in claim 18, wherein the additional substance effects mechanical damping properties of the electrical insulation layer.

29. The method as claimed in claim 28, wherein the additional substance comprises a polyurethane.

30. The method as claimed in claim 18, wherein the additional substance comprises lead particles or lead filaments.

31. The method as claimed in claim 18, wherein the additional substance is particles or fibers.

32. The method as claimed in claim 18, wherein the at least one additional substance is a material of the carrier material.

33. The method as claimed in claim 18, wherein the additional substance has a concentration gradient in the electrical insulation layer.

34. A bearing race for a rolling bearing, comprising:
a body having a lateral outer surface, which surrounds the body; and
an electrical insulation layer of the lateral outer surface acting as a bearing race, the electrical insulation layer comprising a resin matrix having a carrier material and an additional substance for effecting electrical or mechanical properties of the electrical insulation layer.
